(19) United States
(12) Patent Application Publication
(10) Pub. No.: US 2021/0269284 A1
(43) Pub. Date: Sep. 2, 2021

(54) SYSTEM FOR CONTROLLING A SERVICE ACCESS ASSOCIATED WITH AN ELEVATOR CAR

(71) Applicant: KONE Corporation, Helsinki (FI)

(72) Inventors: Tapani Talonen, Helsinki (FI); Pekka Halonen, Helsinki (FI); Aki Haikonen, Helsinki (FI); Jari Kantola, Helsinki (FI); Matti Räsänen, Helsinki (FI); Tapio Siironen, Helsinki (FI); Ville Myyryläinen, Helsinki (FI)

(73) Assignee: KONE Corporation, Helsinki (FI)

(21) Appl. No.: 17/172,882

(22) Filed: Feb. 10, 2021

(30) Foreign Application Priority Data
Feb. 28, 2020 (EP) 20160228.1

(51) Int. Cl. B66B 13/18; B66B 5/00

(52) U.S. Cl. CPC B66B 13/185; B66B 5/0056

(57) ABSTRACT

A system for controlling service access associated with an elevator car includes a divider configured to divide an elevator shaft into a plurality of service access zones; and a controller configured to control a locking state of at least one service access from inside the elevator car to the elevator shaft based on a service access zone of the plurality of service access zones at which the elevator car is located.

### TECHNICAL FIELD

The present application relates to the field of elevator systems, and more particularly to elevator safety systems.

### BACKGROUND

In elevator systems with a limited amount of free space in the top or bottom part of an elevator shaft, many elevator maintenance operations for components in the elevator shaft are made by operating from inside an elevator car. The maintenance may be performed, for example, through an opened car roof, flooring or walls or through open car doors. In elevator solutions having a limited amount of headroom above the elevator car at the topmost floor, a permanent and inherent refuge space is located at least partially inside the elevator car, and on the top of car there may not be any free space providing the refuge space. Furthermore, on the bottom of the elevator shaft there may not be free space providing a refuge space. In these situations, it may be crucial to ensure safety of the maintenance operations performed by the maintenance personnel.

### SUMMARY

It is an object to provide a system for controlling a locking state of at least one service access from inside the elevator car to the elevator shaft based on a service access zone of a plurality of service access zones at which the elevator car is located. The objective is achieved by the features of the independent claims. Additional embodiments are described in the dependent claims.

According to a first aspect, there is provided a system for controlling a service access associated with an elevator car. The system comprises means for dividing an elevator shaft into a plurality of service access zones; and means for controlling a locking state of at least one service access, provided from inside the elevator car to the elevator shaft, based on a service access zone of the plurality of service access zones at which the elevator car is located.

In an example embodiment, the means for controlling the locking state of the at least one service access are configured to disable opening of the at least one service access in at least one service access zone of the plurality of service access zones.

In an example embodiment, in addition or alternatively, the means for controlling the locking state of the at least one service access comprises a mechanical locking mechanism comprising a first mechanical element associated with the service access and a second mechanical element associated with the elevator shaft; and wherein the first and second mechanical elements are configured to act together to disable opening of the service access in the at least one service access zone of the plurality of service access zones.

In an example embodiment, in addition or alternatively, at least one service access zone corresponds to a length and position of the second mechanical element along the elevator shaft.

In an example embodiment, in addition or alternatively, the first mechanical element comprises at least one lever, safety catch, sleeve, valve, or arm.

In an example embodiment, in addition or alternatively, the second mechanical element comprises a ramp or a tumbler plate.

In an example embodiment, in addition or alternatively, the means for controlling the locking state of the at least one service access comprises an electrical lock coupled to each service access and controlled based on location of the elevator car in the elevator shaft.

In an example embodiment, in addition or alternatively, the means for dividing the elevator shaft into the plurality of service access zones comprises at least one switch coupled to the elevator shaft and configured to indicate borders of the plurality of service access zones.

In an example embodiment, in addition or alternatively, the means for dividing the elevator shaft into the plurality of service access zones comprises a computer device configured to store at least one threshold value associated with location information of borders of the plurality of service access zones.

In an example embodiment, in addition or alternatively, the system further comprises means for detecting that at least one service access is open; and means for disabling movement of the elevator car to a service access zone in which opening of the respective service access is configured to be disabled.

In an example embodiment, in addition or alternatively, the plurality of service access zones comprises an elevator car roof service access disabled zone in which an elevator car roof service access is disabled when the elevator car is located in a top part in the elevator shaft; and an elevator car roof service access enabled zone in which the elevator car roof service access is enabled when the elevator car is located in other parts of the elevator shaft.

In an example embodiment, in addition or alternatively, the plurality of service access zones comprises a middle service access zone in which an elevator car roof service access is enabled and an elevator car floor service access is disabled when the elevator car is located in a middle part in the elevator shaft; a top service access zone in which the elevator car roof service access is disabled, and the elevator car floor service access is disabled when the elevator car is located in a top part in the elevator shaft; a bottom service access zone in which the elevator car roof service access is enabled, and the elevator car floor service access is disabled when the elevator car is located in a bottom part in the elevator shaft; and a close to bottom floor service access zone in which the elevator car roof service access is enabled and the elevator car floor service access is enabled when the elevator car is located close to a bottom part of the elevator shaft.

In an example embodiment, in addition or alternatively, the system further comprises means for preventing driving of the elevator car within a predetermined distance from a counterweight of the elevator car when an elevator car wall service access is in use.

According to a second aspect, there is provided an elevator system comprising a system of the first aspect.

According to a third aspect, there is provided a method for controlling a service access associated with an elevator car. The method comprises dividing an elevator shaft into a plurality of service access zones; and controlling a locking state of at least one service access, provided from inside the elevator car to the elevator shaft, based on a service access zone of the plurality of service access zones at which the elevator car is located.

According to a fourth aspect, there is provided a computer program comprising instructions to cause the system of the first aspect to execute the method of the third aspect.

The above discussed means may be implemented, for example, using at least one processor, at least one processor and at least one memory connected to the at least one processor, or at least one processor, at least one memory connected to the at least one processor and an input/output interface connected to the at least one processor.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a system for controlling a locking state of at least one service access in an elevator car based on a service access zone of an elevator shaft according to an example embodiment.

FIG. 2 illustrates a service access in an elevator car according to an example embodiment.

FIG. 3 illustrates clearances of an elevator system between elevator components and an elevator shaft according to an example embodiment.

FIG. 4A illustrates an elevator shaft divided into a plurality of service access zones according to an example embodiment.

FIG. 4B illustrates an elevator shaft divided into a plurality of service access zones according to an another example embodiment.

FIG. 5A illustrates operation of a system for controlling a locking state of a service access in an elevator car based on a service access zone of an elevator shaft according to an example embodiment.

FIG. 5B illustrates operation of a system for controlling a locking state of a service access in an elevator car based on a service access zone of an elevator shaft according to another example embodiment.

FIG. 5C illustrates operation of a system for controlling a locking state of a service access in an elevator car based on a service access zone of an elevator shaft according to another example embodiment.

FIG. 6A illustrates a mechanical locking mechanism of a service access when opening the service access is disabled according to an example embodiment.

FIG. 6B illustrates a mechanical locking mechanism of a service access when opening the service access is enabled according to an example embodiment.

FIG. 7A illustrates a mechanical locking mechanism of a service access when opening the service access is disabled according to another example embodiment.

FIG. 7B illustrates a mechanical locking mechanism of a service access when opening the service access is enabled according to another example embodiment.

FIG. 8A illustrates a close-up of the mechanical locking mechanism in FIG. 6A according to an example embodiment.

FIG. 8B illustrates a close-up of the mechanical locking mechanism in FIG. 6B according to an example embodiment.

FIG. 9A illustrates a close-up of another mechanical locking mechanism of a service access when opening the service access is disabled according to an example embodiment.

FIG. 9B illustrates a close-up of another mechanical locking mechanism of a service access when opening the service access is enabled according to an example embodiment.

FIG. 10A illustrates a close-up of the mechanical locking mechanism in FIG. 7A according to an example embodiment.

FIG. 10B illustrates a close-up of the mechanical locking mechanism illustrated in FIG. 7B according to an example embodiment.

FIG. 11 illustrates a mechanical locking mechanism of a service access in an elevator car where a second mechanical element of the mechanical locking mechanism is mounted perpendicular to an elevator shaft according to an example embodiment.

FIG. 12 illustrates a mechanical locking mechanism of a service access in an elevator car where a second mechanical element of the mechanical locking mechanism is mounted perpendicular to an elevator shaft according to an example embodiment.

FIG. 13 illustrates a method for controlling service access associated with an elevator car according to an example embodiment.

### DETAILED DESCRIPTION

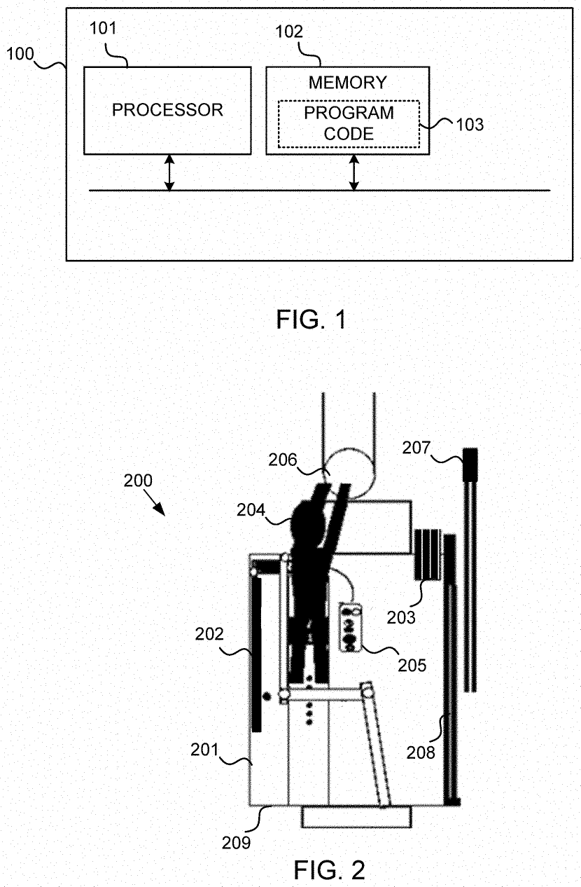

FIG. 1 illustrates a system 100 for controlling at least one service access associated with an elevator car based on a service access zone of an elevator shaft according to an example embodiment.

The system 100 comprises means for dividing an elevator shaft into a plurality of service access zones, and means for controlling a locking state of the at least one service access, provided from inside the elevator car to the elevator shaft, based on a service access zone of the plurality of service access zones at which the elevator car is located. The means may be partially or completely implemented, for example, by at least one processor 101 and at least memory 102 connected to the at least one processor 101. The at least one processor 101 may comprise one or more general purpose processors, microprocessors, digital signal processors, micro-controllers, and the like, programmed according to the teachings of the example embodiments, as will be appreciated by those skilled in the computer and/or software art(s). The at least one memory 102 may be, for example, a hard disk, optical disk, magneto-optical disk, RAM, and the like. One or more databases can store the information used to implement example embodiments described herein. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

In another example embodiment, the means for diving and means for controlling may be at least partially implemented using mechanical and/or electro-mechanical element or components. In an example embodiment, the system 100 may further comprise locking means. The locking means may comprise, for example, at least one electrical lock configured on at least one service access in an elevator car. In an example embodiment, the electrical lock may be controlled based on location of the elevator car in the elevator shaft. For example, the electrical lock may be configured to prevent the use of a service access when the elevator car is located in a service access zone in which the service access is configured to be disabled. The service access may provide access from inside the elevator car to the elevator shaft. The service access may be located, for example, in an elevator car roof, elevator car wall and/or in elevator car floor. The locking means may be controllable, for example, by the at least one processor 101.

In an example embodiment, the locking means may comprise a mechanical locking mechanism. The mechanical locking mechanism may comprise a first locking element associated with at least one service access. The mechanical locking mechanism may further comprise a second locking element associated with the elevator shaft. The locking means may be configured to disable and enable opening of the at least one service access in the elevator car. In an example embodiment, the first and second mechanical elements may be configured to act together to disable opening of the service access in the at least one service access zone of the plurality of service access zones.

In an example embodiment, the locking means may comprise at least one component configured to divide the elevator shaft into the plurality of service access zones. In an example embodiment, the elevator shaft may be divided into the plurality of service access zones with the mechanical locking mechanism such that at least one service access zone corresponds to a length and position of the second mechanical element along the elevator shaft. The first and the second mechanical elements may engage when the elevator car is in a first service access zone, and the first and the second mechanical elements may disengage when the elevator car is outside the first service access zone or in a second service access zone.

In an example embodiment, the locking means comprise at least one switch. The at least one switch may be used to divide the elevator shaft into the plurality of service access zones such that at least one service access zone is located above the switch and at least one service access zone below the switch. Hence, a switch level may indicate a border of two service access zones in the elevator shaft. The at least one electrical lock may be configured to lock or unlock the at least one service access in response to the elevator car moving from one service access zone to another service access zone. The electrical lock may be configured to lock and unlock the service access, for example, in response to receiving a control signal from the at least one switch. The switch may be for example, a bi-stabile limit switch or an electrical sensor.

In an example embodiment, the system 100 may comprise a service limit device configured to ensure that the elevator car cannot move to a restricted service access zone when at least one service access in open. In the restricted service access zone, opening of the respective service access may be configured to be disabled by the locking means. The service limit device may comprise service limit switches configured to stop the elevator car when it is too close to a top or bottom of the elevator shaft while the elevator is in an inspection drive mode.

In an example embodiment, the at least one electrical lock may be controlled by a computer device. The at least one electrical lock may be controlled based on location information of the elevator car in the elevator shaft. The location information of the elevator car may be received by the computer device. The location information may be received, for example, from a car position encoder. The location information may comprise, for example, absolute location feedback of the elevator car. The computer device may be configured to divide the elevator shaft into the plurality of service access zones. In an example embodiment, the computer device may be configured to store at least one threshold value associated with location information of borders of the plurality of service access zones.

When the system 100 is configured to implement some functionality, some component and/or components of the system 100, for example, the at least one processor 101 and/or the memory 102, may be configured to implement this functionality. Furthermore, when the at least one processor 101 is configured to implement some functionality, this functionality may be implemented using program code 103 comprised, for example, in the at least one memory 102.

FIG. 2 illustrates a service access in an elevator car according to an example embodiment. The elevator car 201 may comprise one or more service accesses 203, 208, 209 provided from inside the elevator car 201 towards an elevator shaft.

The elevator car 201 may comprise a service access 203 located on the elevator car roof. The service access 203 may be opened from inside the elevator car 201 by opening a car ceiling 202 and car roof panels. A maintenance person 204 may work on shaft components 206 and landing door components 207 via the service access 203. Alternatively, the landing door components may be serviced via car doors 208. The maintenance person 104 may engage an inspection drive unit 205 to the elevator car 202 in order to perform inspection drives while at least one of the service accesses may be open. One service access 209 may be located on the elevator car floor such that the maintenance person 204 may have access to pit components. The maintenance person 204 may engage an inspection drive unit 205 to the elevator car 202 in order to perform an inspection drive while at least one of the service accesses is open. However, there may be a risk of injury if the maintenance person opens one service access and the elevator moves for some reason and there is not sufficient clearance between the elevator car and the shaft or shaft equipment.

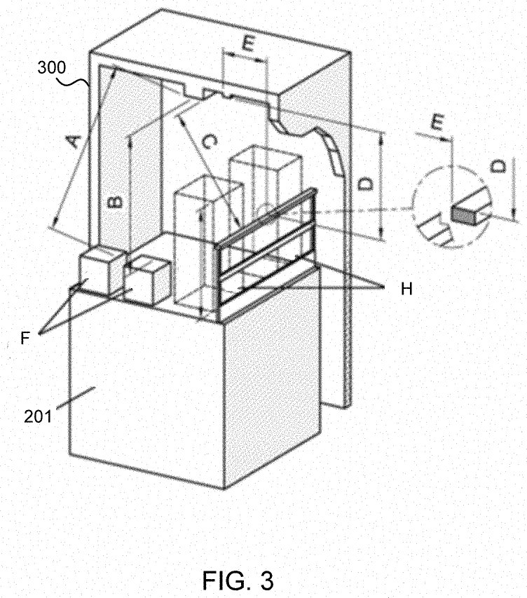

An example of clearances of an elevator system between elevator components and an elevator shaft 300 is illustrated in FIG. 3. On top of the elevator shaft 300 there need to be clearances between highest components on car roof and the top of the elevator shaft 300 to eliminate a risk of crushing. For example, it may be that at least a 300 mm clearance D is needed between a car balustrade and a top of elevator shaft ceiling for head protection. The car balustrade may be, for example, a separate balustrade located on the car roof. Alternatively, elevator car walls may function as the balustrades when the maintenance is performed through an opened car roof from inside the elevator car 201. For body protection, it may be that at least 500 mm clearances A, B, C are needed between car top components F, H and the top of the shaft ceiling. The clearance for head protection may be measured from the highest point of the top of the elevator shaft such that there is enough space for the head protection. The body protection may be measured from the lowest point of the top of the elevator shaft. The needed clearances A, B, C, D may be measured when the elevator car is in its top-most position in the elevator shaft 300.

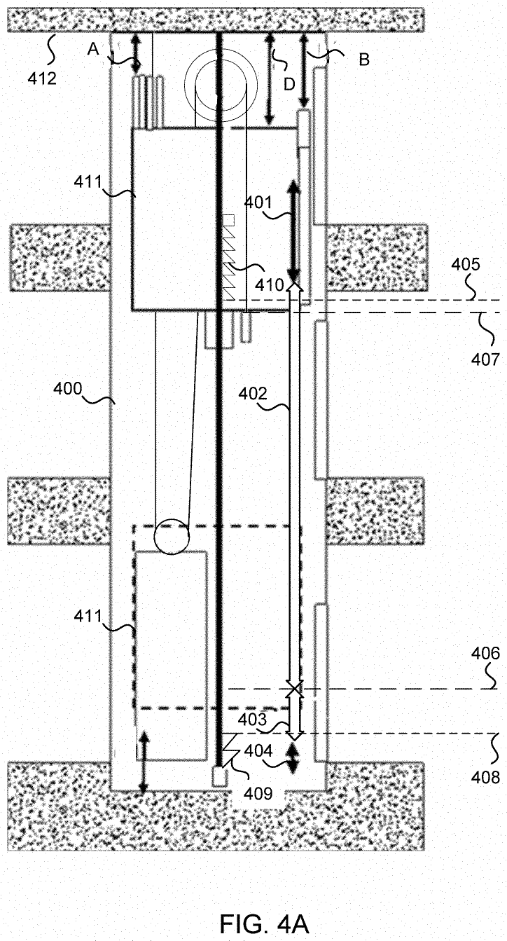

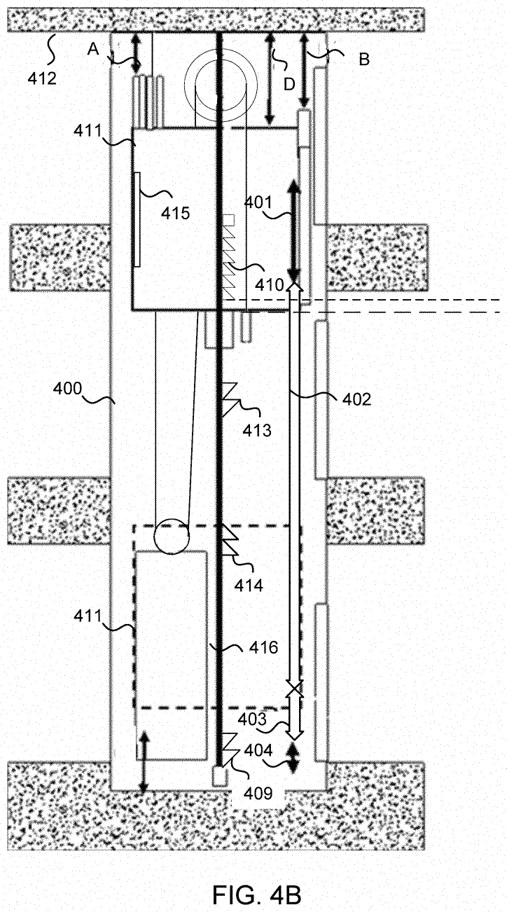

FIG. 4A illustrates an elevator shaft 400 divided into a plurality of service access zones 401, 402, 403, 404 according to an example embodiment.

The elevator shaft 400 may have a low headroom space in a top portion of the elevator shaft 400. In an example embodiment, the plurality of service access zones 401, 402, 403, 404 may comprise a middle service access zone 402 in which the elevator car roof service access is enabled and an elevator car floor service access is disabled when the elevator car is located in a middle part in the elevator shaft 400. The plurality of service access zones 401, 402, 403, 404 may further comprise a top service access zone 401 in which the elevator car roof service access is disabled and the elevator car floor service access is disabled when the elevator car is located in a top part in the elevator shaft 400. The plurality of service access zones 401, 402, 403, 404 may further comprise a bottom service access zone 404 in which the elevator car roof service access is enabled and the elevator car floor service access is disabled when the elevator car is located in a bottom part in the elevator shaft 400. The plurality of service access zones 401, 402, 403, 404 may further comprise a close to bottom floor service access zone 403 in which the elevator car roof service access is enabled and the elevator car floor service access is enabled when the elevator car is located close to a bottom part of the elevator shaft.

The top service access zone 401 may be associated with sufficient clearances A, B, D such that there is enough head space between a car balustrade (or car walls) and highest components of the elevator car 411 and the top ceiling 412 of the elevator shaft 400.

The plurality of service access zones 401, 402, 403, 404 may be associated with at least one electrical limit device 406, 407 on top and/or bottom part of the shaft 400. The electrical limit devices 406, 407 may comprise, for example, one or more electrical or mechanical switches, such as bi-stabile limit switches. The one or more switches may be coupled to a control system configured to control a locking state of at least one service access in the elevator car 411 based on the inputs from the at least one switch. For example, opening of the elevator car roof service access may be disabled in response to the elevator car moving at the position of the at least one switch located at a border of the top service access zone 401. The opening of the elevator car roof service access may be disabled, for example, with an electrical lock associated with the elevator car roof service access and controlled based on location of the elevator car 411.

The plurality of service access zones 401, 402, 403, 404 may be associated with at least one mechanical limit device 409, 41 on top and/or bottom part of the shaft 400. References 408 and 405 may illustrate starting points for the at least one mechanical limit device 409, 410. The at least one mechanical limit device 409, 410 may be configured to disable movement of the elevator car 411 to a service access zone in which opening of the respective service access is configured to be disabled. For example, if the elevator car floor service access is opened at the close to bottom service access zone 403, the mechanical limit device 409 at the bottom part of the shaft 400 may be triggered and the mechanical limit device 409 may prevent movement of the elevator car 411 to the bottom service access zone 404. Similarly, if the elevator car roof service access is opened at a zone in which the elevator car roof service access is enabled, the mechanical limit device 410 at the top part of the shaft 400 may be triggered and the mechanical limit device 410 may prevent movement of the elevator car 411 to the top service access zone 401 401 while the elevator car roof service access is open.

FIG. 4B illustrates an elevator shaft divided into a plurality of service access zones according to an another example embodiment.

As illustrated in FIG. 4B, the system may comprise means 413, 414 for preventing driving of the elevator car 411 within a predetermined distance from a counterweight 416 of the elevator car 411 when an elevator car wall service access 415 is in use. As illustrated in FIG. 4B, a service access 415 may be arranged in a wall of the elevator car 411, i.e. on a side facing or close to a counterweight 416. This may lead to a situation that, if the service access 415 is open, i.e. in use, an inspection drive should be prevented in in an area where the elevator car 411 meets the counterweight 416. For the prevention, mechanical limit devices 413, 414, that may be similar to the mechanical limit devices 409, 410, may be arranged, for example, in a guide rail. For example, if the service access 415 is opened in a bottom or top part of the elevator shaft 400, and the elevator car 411 is then driven in an inspection drive mode, the mechanical limit devices 413, 414 will stop the elevator car 411 before it travels too close to the counterweight 416. This prevention is similar to the prevention that may be implemented when the driving of the elevator car may be prevented to a top part of the elevator shaft 400 when an elevator car roof service access is in use and/or to a bottom part of the elevator shaft 400 when an elevator car floor service access is in use.

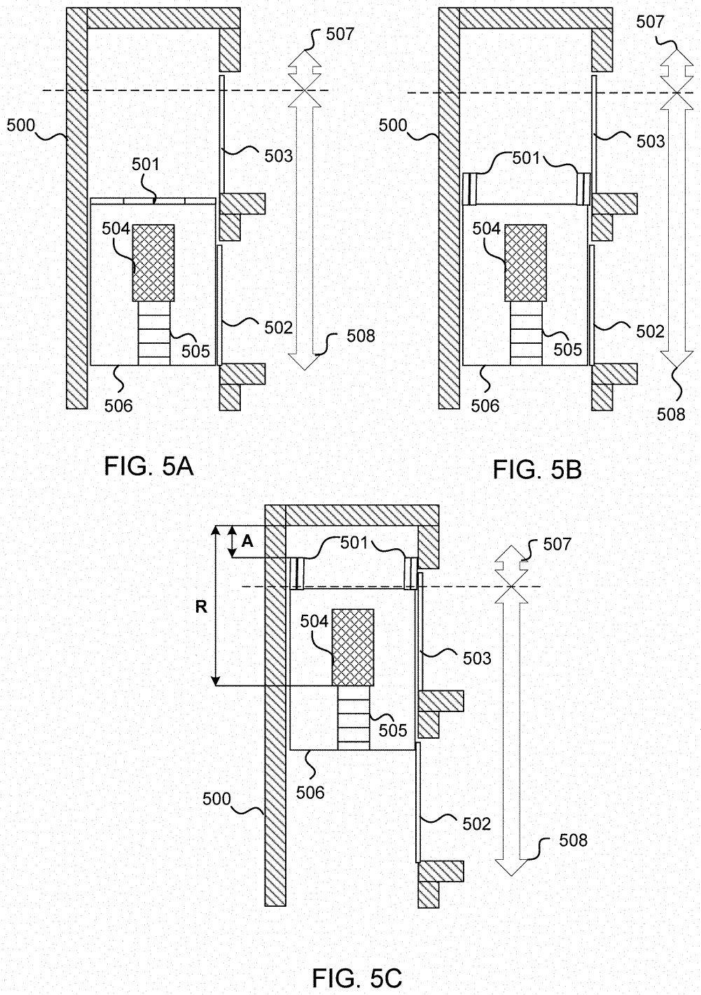

FIGS. 5A, 5B and 5C illustrate operations of a system for controlling a locking state of a service access in an elevator car based on a service access zone of an elevator shaft 500 according to an example embodiment.

Maintenance of components located in the headroom space of the elevator shaft may be performed safely with the above described system. First, as illustrated in FIG. 5A, an elevator car 506 may be driven to a second top landing 502. The second top landing 502 may be located in a zone 508 in which elevator car roof service access is enabled. A maintenance person may enter the elevator car 506 in the second top landing 502, and open elevator car roof service access 501. Opening of the elevator car roof service access 501 may be enabled because the elevator car is located in the middle service access zone 402, as illustrated in FIG. 5B. The elevator car roof service access may comprise a car ceiling and elevator car roof panels. Once the elevator car roof is open, the maintenance person may proceed to engage an inspection drive mode and drive the elevator car 506 with the inspection drive from inside the elevator car 506. Above the zone 508 in which elevator car roof service access is enabled, there may be a zone 507 in which in which opening of the elevator car roof service access 501 may be configured to be disabled. Hence, when the elevator car 506 moves up, a service limit switch may stop the elevator car 506 before the elevator car 506 reaches the zone 507 with the car roof service access 501 open, as illustrated in FIG. 5C.

Alternatively, location of the elevator car 506 may be monitored, for example, with a car positioning device, and the elevator car 506 may be stopped before accessing the zone 507 based on the location information of the elevator car 506. In an example embodiment, the location of the elevator car 506 may be compared to threshold values associated with location information of borders of the service access zones 507, 508. If the elevator car 506 car is passing a service access limit, there can be additional pre-triggered service limit device that stops car before the zone 507. The service limit device may be triggered in response to opening of the elevator car roof service access 501.

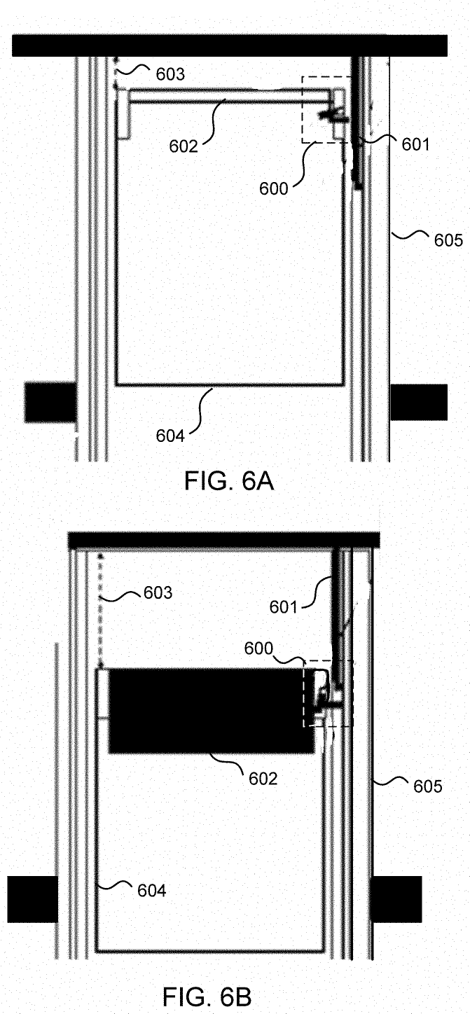

FIG. 6A illustrates a mechanical locking mechanism 600, 601 of an elevator car roof service access 602 when opening of the elevator car roof service access 602 is disabled according to an example embodiment.

The mechanical locking mechanism 600, 601 may be configured to disable opening of the elevator car roof service access 602 in at least one service access zone. The mechanical locking mechanism 600, 601 may comprise a first mechanical element 600 associated with the elevator car roof service access 602. The first mechanical element 600 may be, for example, a lever, a safety catch, a sleeve, a valve, or an arm. In an example embodiment, the first mechanical element 600 may comprise a plurality of levers, safety catches, sleeves, valves, arms, or a combination thereof. In FIG. 6, the first mechanical element 600 may be coupled to the elevator car roof service access 602. In an another example embodiment, the first mechanical element 600 may be coupled to an elevator car floor service access or an elevator car door service access.

The mechanical locking mechanism may comprise a second mechanical element 601 associated with an elevator shaft 605. The second mechanical element 601 may be, for example a ramp. The ramp may be fixed, for example, to elevator shaft structures or mechanics. The ramp may be fixed, for example, to a guiderail, a bracket, an elevator shaft wall or a landing door railing system. The length of the ramp may be adjusted according to a height of headroom and/or unsafe car position zone. The unsafe car position zone may be, for example, a top service access zone, a middle service access zone, or a bottom service access zone, depending on which service access is configured to be disabled by the mechanical locking mechanism. In the unsafe car position zone there may be only little clearance 603 between the car top and shaft ceiling. In other words, at least one service access zone may correspond to the length and position of the second mechanical element 601 along the elevator shaft 605. In an embodiment, a tumbler plate may be used instead of the ramp.

The first and the second mechanical elements 600, 601 may be configured to act together to disable opening of the service access 602 in the at least one service access zone. In an example embodiment, when the elevator car 604 moves to the service access zone starting from the lower end of the second mechanical element 601, the second mechanical element 601, for example, the ramp, may cause the first mechanical element 600, for example, the safety catch, to move towards the elevator car roof service access such that the safety catch disables opening the elevator car roof service access 602. The elevator car roof service access 602 may be kept locked by the first mechanical element 600 as long as the elevator car 604 is positioned in the service access zone associated with the second mechanical element 601. When the elevator car 604 moves downwards and outside the service access zone, the safety catch may have space to move away and again enable the use of the elevator car roof service access 602. Outside the service access zone, the clearance 603 between the elevator car top and the shaft ceiling may be sufficient to enable safe maintenance work. Hence, opening of the elevator car roof service access 602 may be enabled, as illustrated in FIG. 6B.

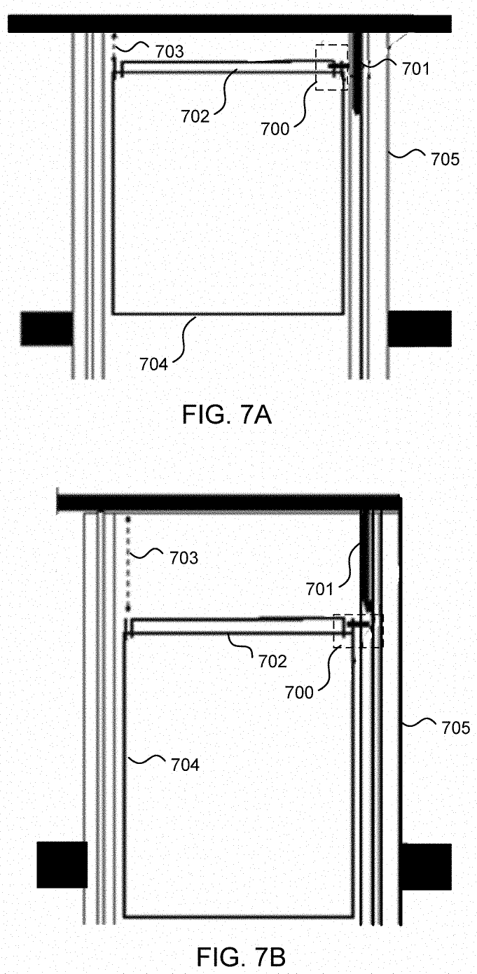

FIGS. 7A and 7B illustrate a mechanical locking mechanism of a service access when opening the service access is disabled and enabled according to another example embodiment.

The locking mechanism in FIGS. 7A and 7B is similar to the mechanical locking mechanism described in FIGS. 6A and 6B. The mechanical locking mechanism 700, 701 comprises a second mechanical element 701, which may be a ramp attached, for example, to a guiderail located in the elevator shaft 705. The mechanical locking mechanism may further comprise a first mechanical element 700 which may be a different kind of implementation of a safety catch compared to the safety catch illustrated in FIGS. 6A, 6B. The principle of the mechanical locking mechanism 700, 701 is similar as described above: the length and position of the second mechanical element 701 may define a service access zone in which a clearance 703 may not be sufficient for safe maintenance work. Hence, the second mechanical element 701 may be configured to act together with the first mechanical element 700 coupled to the elevator car roof service access 702 to disable opening the elevator car roof service access 702 when the elevator car 704 arrives at the position of the second mechanical element 701. The length of the second mechanical element 701 may be adjusted so that at the bottom end of the second mechanical element 701, the clearance 703 between the elevator car top and the shaft ceiling is sufficient to provide a sufficient refuge space.

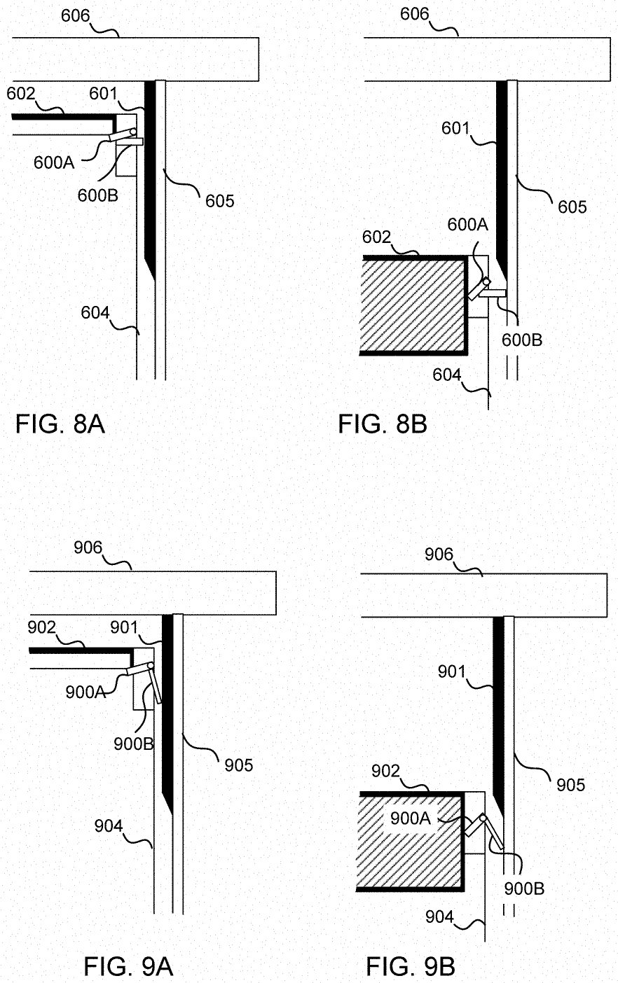

FIG. 8A illustrates a closer illustration of the mechanical locking mechanism 600, 601 illustrated in FIGS. 6A and 6B when opening of the service access 602 is disabled according to an example embodiment. FIG. 8B illustrates the same mechanical locking mechanism 600, 601 when the opening of the service access 602 is enabled.

The first mechanical element 600 may comprise a lever 600A and a safety catch 600B. The lever 600A may turn if at least one elevator car roof panel 602 is opened. The lever 600A may be used, for example, for mechanically blocking the car roof service access from opening, as illustrated in FIGS. 8A, 8B, or for operating an electrical safety control switch for monitoring car roof panel movement. Monitoring the car roof panel movements may be used to, for example, a person detection on roof, or roof opening monitoring. The separate safety catch 600B may disable or enable the movement of the lever 600A. The lever 600A may, for example, rotate around a hinge coupled to the elevator car 604. In an example embodiment, a mechanical sleeve may be used to control the movement of the lever 600A instead of the safety catch. Further, the second mechanical element 601 may be attached, for example, on a wall of the elevator shaft 605. An upper end of the second mechanical element 601 starts from a ceiling 606 or from close to the ceiling 606 of the elevator shaft 605. A lower end of the second mechanical element 601 may end at a border of two service access zones, wherein in the upper service access zone opening of the elevator car roof 602 is disabled and in the lower service access zone opening of the elevator car roof 602 is enabled.

FIG. 9A illustrates a closer illustration of another mechanical locking mechanism of a service access when opening the service access is disabled according to an example embodiment. The mechanical locking mechanism may comprise a similar second mechanical element 901, such as a ramp coupled to an elevator shaft structure 905, as already described earlier. The second mechanical element 901 may be positioned to extend upwards from the lower border of the top service access zone in which opening of the elevator car roof service access 902 is configured to be disabled.

The mechanical locking mechanism may comprise a first mechanical element that comprises two parts 900A, 900B. The first mechanical element may comprise, for example, two levers 900A, 900B fixedly coupled to each other and hinged to the elevator car roof frame. The first mechanical element may be mounted to a top part of the elevator car 904, for example, to an elevator car roof frame. The first mechanical element may be configured to rotate in response to opening of at least one elevator car roof panel 902. When the elevator car 904 is positioned to face the second mechanical element 901, movement of the first mechanical element is prevented as the second lever 900B positioned closed to the second mechanical element 901 does not have space to rotate. When the elevator car 904 moves outside of the service access zone defined by the second mechanical element 901, the first mechanical element now has room to rotate and allow opening of the at least one elevator car roof panel 902. FIG. 9B illustrates a close-up of the mechanical locking mechanism 900A, 900B, 901 when opening of the elevator car roof panel 902 is enabled.

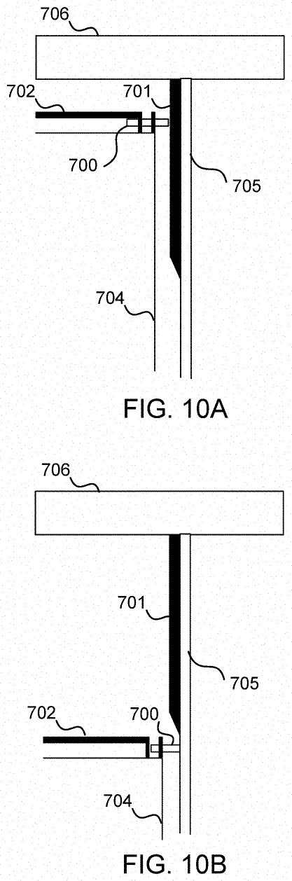

FIG. 10A illustrates a closer illustration of the mechanical locking mechanism illustrated in FIGS. 7A, 7B according to an embodiment. The second mechanical element 701 of the mechanical locking mechanism may be coupled on the elevator shaft structure 705, for example, extending upwards from the lower border of the top service access zone.

The first mechanical element 700 may be a safety catch configured to move in a horizontal direction. In an embodiment, when the elevator car 704 moves upwards, the ramp may cause the safety catch to be pushed inwards such that it disables opening of the elevator car roof. When the first mechanical element 700 is not facing the ramp anymore, the safety catch may move outwards such that it does not any more block opening of the elevator car roof service access 702.

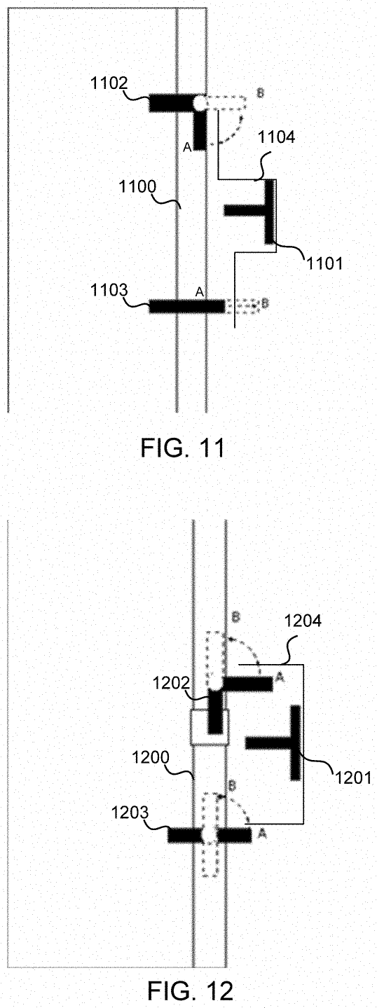

FIGS. 11 and 12 illustrate a cross-section as seen from above of a mechanical locking mechanism of a service access 1100 in an elevator car where a tumbler plate or a ramp 1104, 1204 that is fixedly connected to a guide rail 1101, 1201 moves a spring-loaded safety catch 1102, 1103, 1202, 1203.

Even if various example embodiments have been discussed above in view of an elevator car roof service access and a refuge space on the top of the elevator car, the same solutions and principles apply also for other safety areas in the elevator shaft and for other service accesses, for example, in a wall or floor of the elevator car. Further, in addition to refuge spaces above or below the elevator car, the refuge space may be associated also with respect to a counterweight of the elevator car.

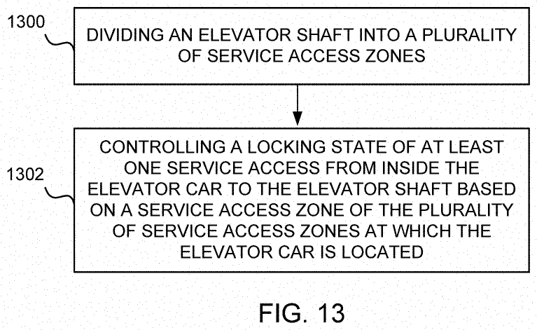

FIG. 13 illustrates a method for controlling service access associated with an elevator car according to an example embodiment.

At 1300, an elevator shaft may be divided into a plurality of service access zones. At 1302 a locking state of at least one service access, provided from inside the elevator car to the elevator shaft, is controlled based on a service access zone of the plurality of service access zones at which the elevator car is located. The method may be partially or completely implemented, for example, by an apparatus comprising at least one processor and at least on memory connected to the at least one processor. The at least one memory may comprise at least one computer program controlling operation of the at least one processor.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A system for controlling a service access associated with an elevator car, the system comprising:
a divider configured to divide an elevator shaft into a plurality of service access zones; and
a controller configured to control a locking state of at least one service access, provided from inside the elevator car to the elevator shaft, based on a service access zone of the plurality of service access zones at which the elevator car is located.

2. The system of claim 1, wherein the controller is configured to disable opening of the at least one service access in at least one service access zone of the plurality of service access zones.

3. The system of claim 2, wherein the controller comprises a mechanical locking mechanism comprising a first mechanical element associated with the service access and a second mechanical element associated with the elevator shaft,
wherein the first and second mechanical elements are configured to act together to disable opening of the service access in the at least one service access zone of the plurality of service access zones.

4. The system of claim 3, wherein at least one service access zone corresponds to a length and position of the second mechanical element along the elevator shaft.

5. The system of claim 3, wherein the first mechanical element comprises at least one lever, safety catch, sleeve, valve, or arm.

6. The system of claim 3, wherein the second mechanical element comprises a ramp or a tumbler plate.

7. The system of claim 1, wherein the controller comprises an electrical lock coupled to each service access and controlled based on a location of the elevator car in the elevator shaft.

8. The system of claim 1, wherein the divider comprises at least one switch coupled to the elevator shaft and configured to indicate borders of the plurality of service access zones.

9. The system of claim 1, wherein the divider comprises a computer device configured to store at least one threshold value associated with location information of borders of the plurality of service access zones.

10. The system of claim 1, wherein the system further comprises:
a detector configured to detect that at least one service access is open; and
a mechanism configured for disabling movement of the elevator car to a service access zone in which opening of the respective service access is configured to be disabled.

11. The system of claim 1, wherein the plurality of service access zones comprises:
an elevator car roof service access disabled zone in which an elevator car roof service access is disabled when the elevator car is located in a top part in the elevator shaft; and
an elevator car roof service access enabled zone in which the elevator car roof service access is enabled when the elevator car is located in other parts of the elevator shaft.

12. The system of claim 1, wherein the plurality of service access zones comprises:
a middle service access zone in which an elevator car roof service access is enabled and an elevator car floor service access is disabled when the elevator car is located in a middle part in the elevator shaft;
a top service access zone in which the elevator car roof service access is disabled, and the elevator car floor service access is disabled when the elevator car is located in a top part in the elevator shaft;
a bottom service access zone in which the elevator car roof service access is enabled, and the elevator car floor service access is disabled when the elevator car is located in a bottom part in the elevator shaft; and
a close to bottom floor service access zone in which the elevator car roof service access is enabled and the elevator car floor service access is enabled when the elevator car is located close to a bottom part of the elevator shaft.

13. The system of claim 1, further comprising:
a mechanism configured to prevent driving of the elevator car within a predetermined distance from a counterweight of the elevator car when an elevator car wall service access is in use.

14. An elevator system comprising the system of claim 1.

15. A method for controlling service access associated with an elevator car, the method comprising:
dividing an elevator shaft into a plurality of service access zones; and
controlling a locking state of at least one service access from inside the elevator car to the elevator shaft based on a service access zone of the plurality of service access zones at which the elevator car is located.

16. A computer program embodied on a non-transitory computer readable medium and comprising instructions to cause the system of claim 1 to execute a method comprising:
dividing the elevator shaft into the plurality of service access zones; and
controlling the locking state of the at least one service access from inside the elevator car to the elevator shaft based on the service access zone of the plurality of service access zones at which the elevator car is located.

17. The system of claim 4, wherein the first mechanical element comprises at least one lever, safety catch, sleeve, valve, or arm.

18. The system of claim 4, wherein the second mechanical element comprises a ramp or a tumbler plate.

19. The system of claim 5, wherein the second mechanical element comprises a ramp or a tumbler plate.

20. The system of claim 2, wherein the controller comprises an electrical lock coupled to each service access and controlled based on a location of the elevator car in the elevator shaft.
